(19) United States
(12) Patent Application Publication
(10) Pub. No.: US 2015/0103101 A1
(43) Pub. Date: Apr. 16, 2015

(54) DISPLAY DEVICE AND DRIVING METHOD THEREOF

(71) Applicant: Samsung Display Co., Ltd., Yongin-si (KR)

(72) Inventors: Eun-Ho LEE, Suwon-si (KR); Jung-Taek KIM, Seoul (KR); Cheol-Woo PARK, Suwon-si (KR); Bong-Hyun YOU, Yongin-si (KR); Hyun-Dae LEE, Hwaseong-si (KR); Ji-Woong JEONG, Yongin-si (KR)

(73) Assignee: Samsung Display Co., Ltd., Yongin-si (KR)

(21) Appl. No.: 14/185,839

(22) Filed: Feb. 20, 2014

(30) Foreign Application Priority Data
Oct. 10, 2013 (KR) 10-2013-0120774

(51) Int. Cl. G09G 5/391

(52) U.S. Cl. CPC G09G 5/391
USPC 345/667

(57) ABSTRACT

A display device and a driving method for converting a low-resolution image into a high-resolution image and preventing a visible boundary between partitioned display areas are disclosed. One inventive aspect includes a display panel, a dividing control unit and a scaler. The display panel includes panel areas. The dividing control unit divides an input image into sub-images and the scaler scales the sub-images. The inventive aspect further includes an extra image removing unit and a driver. The extra image removing unit removes an scaled extra image from the scaled sub-image so that the driver provides the processed sub-image to the corresponding panel area.

### CROSS-REFERENCE TO RELATED APPLICATIONS

This application claims priority to and the benefit of Korean Patent Application No. 10-2013-0120774, filed on Oct. 10, 2013, with the Korean Intellectual Property Office, the content of which is incorporated herein in its entirety by reference.

### BACKGROUND

1. Field

The disclosed technology generally relates to a display device and a driving method for converting a low-resolution image into a high-resolution image and preventing a visible boundary between partitioned display areas.

2. Description of the Related Technology

As the resolution of display devices becomes higher, it is required to display image contents from a low-resolution image data signal to high-resolution display devices. A conventional scaler can convert a low-resolution image data signal into a high-resolution image data signal.

A conventional scaler includes, for example, an HD scaler to display an image data signal having resolution of SD (Standard Definition, 720*480) in a HD (High Definition, 1,920*1,080) display device, and an UD scaler to display an image data signal having resolution of HD (High Definition, 1,920*1,080) in a UD (Ultra Definition, 3,840*2,160) display device.

There is also a conventional method of using a QUD scaler or a conventional UD scaler so as to display an image data signal having UD resolution in a display device beyond QUD (Quad Ultra Definition, 7,680*4,320).

In such an UD scaler method, an image data signal having UD resolution is divided, each of the divided images is upscaled by using the UD scaler and is displayed in partitioned regions of the QUD display device.

However, when using the conventional UD scaler, there may appear an image quality problem in which a boundary between the partitioned regions of the QUD display device is visible.

### SUMMARY OF CERTAIN INVENTIVE ASPECTS

Various aspects of the disclosed technology are directed to a display device capable of preventing a visibility of a boundary between partitioned areas of a display panel when an input image signal is scaled and multi-partitioned to be displayed in the display panel, and to a driving method thereof.

According to an aspect of the disclosed technology, a display device includes a display panel partitioned into a plurality of panel areas, a dividing control unit configured to divide an input image into a plurality of sub-images, wherein each of the sub-images includes a sub-prototype image corresponding to a panel area and extra images corresponding to at least one boundary of the adjacent panel areas, a scaler configured to scale the sub-images, an extra image removing unit configured to remove an scaled extra image from the scaled sub-image such that the scaled sub-image fits into the corresponding panel area, and a driver configured to provide the scaled sub-prototype image to the corresponding panel area.

The sub-prototype image can be image data corresponding to a panel area partitioned in a lattice form.

The sub-prototype image can be image data corresponding to a panel area partitioned in a horizontal direction.

The sub-prototype image can be image data corresponding to a panel area partitioned in a vertical direction.

The extra image can include image data corresponding to 4 to 12 pixel lines widthwise and/or lengthwise.

The scaler can include sub-scalers of which the number is equal to the number of the sub-images.

The scaler can convert low-resolution image data into high-resolution image data.

The scaler can comprise a high-definition scaler configured to scale a standard-definition input image.

The scaler can comprise an ultra-definition scaler configured to scale a high-definition input image.

The driver can include a data driving unit configured to apply a data signal to the panel area, a gate driving unit configured to apply a scan signal to the panel area, and a timing controller configured to apply a timing signal to the data driving unit and the gate driving unit.

The display panel can be beyond UD (Ultra Definition, 3,840*2,160).

The display panel can comprise a quad ultra definition display panel.

The dividing control unit can partition the input image into at least four sub-images. The scaler can comprise four sub-scalers.

The dividing control unit can partition the input image into at least four sub-images. The extra image removing unit can comprise four sub-removing units.

According to another aspect of the disclosed technology, a driving method of a display device includes dividing an input image into a plurality of sub-images, wherein each of the sub-images includes a sub-prototype image corresponding to a panel area and an extra image corresponding to at least one boundary of the adjacent panel areas; scaling the sub-images; removing a scaled extra image from the scaled sub-image to fit into the corresponding panel area; and displaying of the scaled sub-prototype images on the corresponding panel area.

Dividing the input image can comprise dividing the input image into sub-images in a lattice shape so as to display the sub-images in a lattice form.

Dividing the input image comprises dividing the input image into four sub-images.

The scaling can convert low-resolution image data into high-resolution image data.

According to another aspect of the disclosed technology, a display device comprising means of displaying images partitioned into a plurality of meanses of displaying sub-images and means of dividing an input image into a plurality of sub-images. Each of the sub-images includes a sub-prototype image and an extra image. The sub-prototype image corresponds to one of the meanses of displaying sub-images and the extra image corresponds to at least one boundary of the adjacent meanses of displaying sub-images. The display device further comprises means of scaling the sub-images and means of removing a scaled extra image from the scaled sub-image such that the sub-image fits into the corresponding means of display sub-images. The display device also comprises means of displaying the scaled sub-prototype image on the corresponding means of displaying sub images.

According to another aspects of the disclosed technology, the display device prevents a visibility of a boundary between partitioned areas of a display panel when an input image signal is scaled and multi-partitioned to be displayed on the display panel, and to a driving method thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the disclosed technology will be more clearly understood from the following detailed description taken in conjunction with the accompanying drawings, in which:

FIG. 1 is a diagram showing a configuration of a display device according to an embodiment of the disclosed technology;

FIGS. 2A and 2B are diagrams showing partition forms of a display panel according to another embodiment of the disclosed technology; and

FIGS. 3 to 6 are diagrams explaining a driving method of a display device according to an embodiment of the disclosed technology.

### DETAILED DESCRIPTION OF CERTAIN INVENTIVE EMBODIMENTS

Advantages and features of the disclosed technology and methods for achieving them will be made clear from embodiments described below in detail with reference to the accompanying drawings. The disclosed technology may, however, be embodied in many different forms and should not be construed as being limited to the embodiments set forth herein. Rather, these embodiments are provided so that this disclosure will be thorough and complete, and will fully convey the scope of the invention to those skilled in the art. The disclosed technology is merely defined by the scope of the claims. Therefore, well-known constituent elements, operations and techniques are not described in detail in the embodiments in order to prevent the disclosed technology from being obscurely interpreted. Like reference numerals refer to like elements throughout the specification.

In the following description, technical terms are used only to explain a specific exemplary embodiment while not limiting the disclosed technology. The terms of a singular form may include plural forms unless referred to the contrary. The terms “include,” “comprise,” “including,” and “comprising,” as used herein, specify a component, a process, an operation, and/or an element but do not exclude other components, processes, operations, and/or elements. It will be understood that although the terms “first” and “second” are used herein to describe various elements, these elements should not be limited by these terms. These terms are only used to distinguish one component from other components.

It will be understood that when a layer, region, or component is referred to as being “formed on,” another layer, region, or component, it can be directly or indirectly formed on the other layer, region, or component. That is, for example, intervening layers, regions, or components may be present.

The drawings and description are to be regarded as illustrative in nature and not restrictive. Like reference numerals designate like elements throughout the specification.

Further, since sizes and thicknesses of constituent members shown in the accompanying drawings are arbitrarily given for better understanding and ease of description, the disclosed technology is not limited to the illustrated sizes and thicknesses.

In the drawings, the thickness of layers, films, panels, regions, etc., are exaggerated for clarity. In the drawings, for better understanding and ease of description, the thicknesses of some layers and areas are exaggerated. It will be understood that when an element such as a layer, film, region, or substrate is referred to as being “on” another element, it is directly on the other element or intervening elements may also be present.

Throughout this specification and the claims that follow, when it is described that an element is “connected” to another element, the element is “directly connected” to the other element or “electrically connected” to the other element through a third element. In addition, unless explicitly described to the contrary, the word “comprise” and variations such as “comprises” or “comprising” will be understood to imply the inclusion of stated elements but not the exclusion of any other elements. Throughout this specification, it is understood that the term “on” and similar terms are used generally and are not necessarily related to a gravitational reference.

Here, when a first element is described as being connected to a second element, the first element is not only directly connected to the second element but may also be indirectly connected to the second element via a third element. Further, some of the elements that are not essential to the complete understanding of the disclosed technology are omitted for clarity. Also, like reference numerals refer to like elements throughout.

The spatially relative terms “below”, “beneath”, “lower”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

The terminology used herein is for the purpose of describing particular embodiments only and is not construed as limiting the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of mentioned component, step, operation and/or element, but do not exclude the presence or addition of one or more other components, steps, operations and/or elements.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

A display device according to an embodiment of the disclosed technology has a multi-panel drive method. The multi-panel drive method partitions a display panel into a plurality of panel areas and drives the respective panel area by separate drivers.

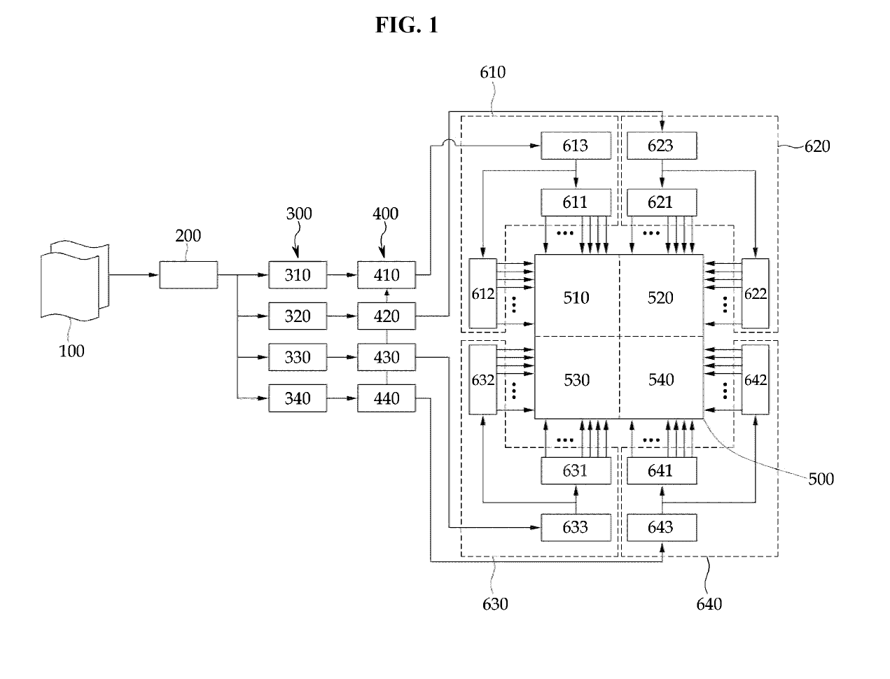

FIG. 1 is a diagram showing a configuration of a display device according to an embodiment of the disclosed technology.

Referring to FIG. 1, the display panel includes a dividing control unit 200, a scaler 300, a removing unit 400, a display panel 500, and a driving unit 600. The dividing control unit 200 divides an input image 100 into a plurality of sub-images, wherein each sub-image include a sub-prototype image corresponding to the panel area and an extra image corresponding to a boundary portion of the adjacent panel areas. The scaler 300 scales the sub-images. The removing unit 400 removes the extra image from the scaled sub-image. The display panel 500 is partitioned into a plurality of panel areas. The driving unit 600 provides the scaled sub-prototype image to the corresponding panel area of the display panel 500 respectively.

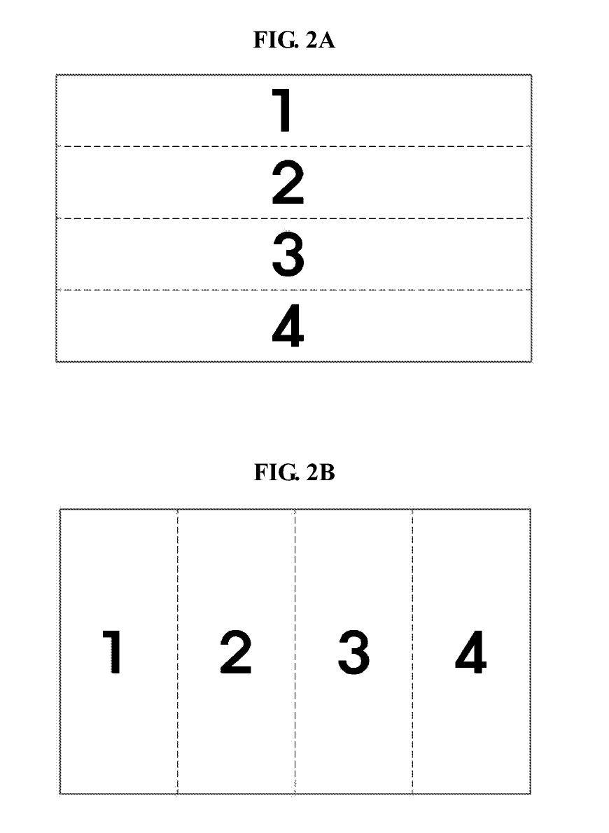

FIG. 1 illustrates the display panel 500 partitioned into a first sub-panel 510, a second sub-panel 520, a third sub-panel 530, and a fourth sub-panel 540 in a lattice form, but it is not limited thereto. In other words, the display panel 500 may be partitioned into at least two areas or more. As illustrated in FIGS. 2A and 2B, the display panel 500 may be partitioned in a horizontal direction (see FIG. 2A) or in a vertical direction (see FIG. 2B). Hereinafter, the display panel 500 will be assumed as being partitioned into four areas in a lattice form for ease of description.

Hereinafter, the display panel 500 will be described as a display device with QUD (Quad Ultra Definition, 7,680*4,320). However, it is not limited thereto, and the display panel 500 may have a resolution of HD (High Definition, 1,920*1,080) or UD (Ultra Definition, 3,840*2,160).

According to an embodiment of the disclosed technology, the display panel 500 is a QUD display device. The respective sub-panels 510, 520, 530, and 540 may include 3,840*2,160 pixels formed in a matrix type, and a plurality of data lines and a plurality of gate lines, which are connected to each pixel.

The display device 500 may include a plurality of drivers 610, 620, 630, and 640 configured to drive the sub-panels 510, 520, 530, and 540 partitioned into a plurality of panel areas respectively. The drivers 610, 620, 630, and 640 may include data driving units 611, 621, 631, and 641 configured to apply a data signal to the data line, gate driving units 612, 622, 632, and 642 configured to apply a scan signal to the gate line, and timing controllers 613, 623, 633, and 643 configured to apply a timing signal to the data driving unit and the gate driving unit respectively.

The input image 100 is a frame-based image. In other words, the dividing control unit 200 may divide the input image 100 of each frame into a plurality of sub-images respectively.

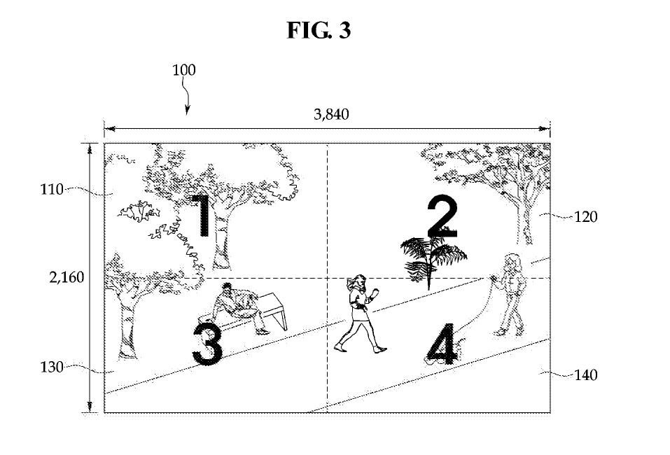

Referring to FIG. 3, the input image 100 may also be divided into four sub-prototype images 110, 120, 130 and 140 corresponding to partitioned areas of the display panel 500 so as to display the sub-images in the lattice form.

According to an embodiment of the disclosed technology, the sub-prototype images 110, 120, 130 and 140 may be image data corresponding to the panel areas divided in the lattice form. According to another embodiment of the disclosed technology, the sub-prototype image 110, 120, 130 and 140 may be image data corresponding to the panel areas divided in a horizontal direction or in a vertical direction.

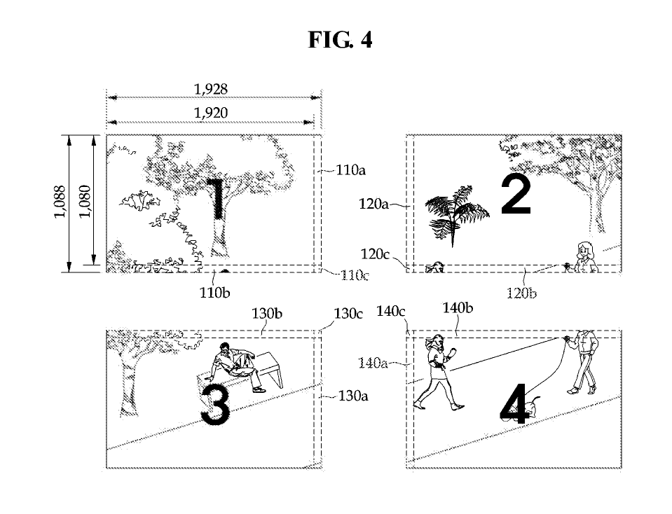

Referring to FIG. 4, the dividing control unit 200 divides an input image 100 into a plurality of sub-images. The sub-images include sub-prototype image and extra image. The sub-prototype image corresponds to the panel areas, and the extra image corresponds to a boundary portion of the adjacent panel areas, respectively.

That is, the dividing control unit 200 may produce a first sub-image which include sub-prototype image 110 corresponding to a panel area and extra image 110a, 110b and 110c corresponding to boundary portions of the adjacent panel areas. In detail, the first sub-image further includes an extra image 110a corresponding to a left boundary portion of sub-prototype image 120, an extra image 110b corresponding to a upper boundary portion of sub-prototype image 130, and an extra image 110c corresponding to a vertex boundary portion of sub-prototype image 140. Herein, the extra image may refer to image data of a plurality of pixel lines adjacent to the sub-prototype image portions.

Similarly, a second sub-image includes extra images 120a, 120b and 120c, a third sub-image includes extra images 130a, 130b and 130c, and a fourth sub-image includes extra images 140a, 140b and 140c, respectively.

The input image 100 is described herein as a UD image data, and thus the input image 100 has a resolution of 3,840*2,160. Therefore, when the input image 100 is defined as being divided into four areas in a lattice shape, each of the sub-images has a resolution of 1,920*1,080.

By the way, referring to FIG. 4, because each sub-image produced by the dividing control unit 200 includes sub-prototype image and extra images so as to prevent a boundary visibility of the display panel areas, each sub-image has a resolution of 1,928*1,088.

In other words, because the dividing control unit 200 divides the input image 100 into the sub-images including sub-prototype image and extra images, each divided sub-image has a resolution of 1,928*1,088 which has 8 more pixel lines, respectively. In detail, as illustrated in FIG. 4, the first sub-image 110 and the extra images 110a(8*1,080), 110b(1,920*8), and 110c(8*8).

The extra images 110a, 110b, and 110c are described herein as including image data corresponding to 8 pixel lines widthwise and/or lengthwise. However, they are not limited thereto, and the extra image 110a, 110b, and 110c may include image data corresponding to 4 to 12 pixel lines widthwise and/or lengthwise, and it may be predetermined or adjusted by a user.

The scaler 300 may scale the sub-images partitioned by the dividing control unit 200. The scaler 300 may increase or decrease an image resolution so that a resolution of an input image is suitable for a resolution of a display panel. The scaler 300 may upscale a resolution of each image partitioned by the dividing control unit 200. That is, the scaler 300 may convert a low-resolution image data signal into a high-resolution image data signal.

Bilinear interpolation or cubic spline interpolation may be used for the above purpose.

The bilinear interpolation calculates a distance-weighted average using a weighted value of only the 4 nearest pixels, and the calculated distance-weighted average is assigned to a pixel value of an input image.

The cubic spline interpolation calculates all 16 input pixels surrounding an output pixel. The cubic spline interpolation changes the number of gray levels in an original image to be relatively low. This provides a clearer image than the bilinear interpolation.

In addition, the scaler 300 may be used without limit if it is an up-scaler generally used in the art.

The scaler 300 may include a sub-scaler of which the number is equal to the number of sub-images partitioned by the dividing control unit 200. According to an embodiment of the disclosed technology, the dividing control unit 200 partitions the input image 100 into four sub-images, and thus the scaler 300 may include four sub-scalers 310, 320, 330, and 340 as illustrated in FIG. 1.

The first sub-scaler 310 may upscale the first sub-image which has the first sub-prototype image 110 and the extra images 110a, 110b, and 110c, the second sub-scaler 320 may upscale the second sub-image which has the second sub-prototype image 120 and the extra images 120a, 120b, and 120c, the third sub-scaler 330 may upscale the third sub-image which has the third sub-prototype image 130 and the extra images 130a, 130b, and 130c, and the fourth sub-scaler 340 may upscale the fourth sub-image which has the fourth sub-prototype image 140 and the extra images 140a, 140b, and 140c.

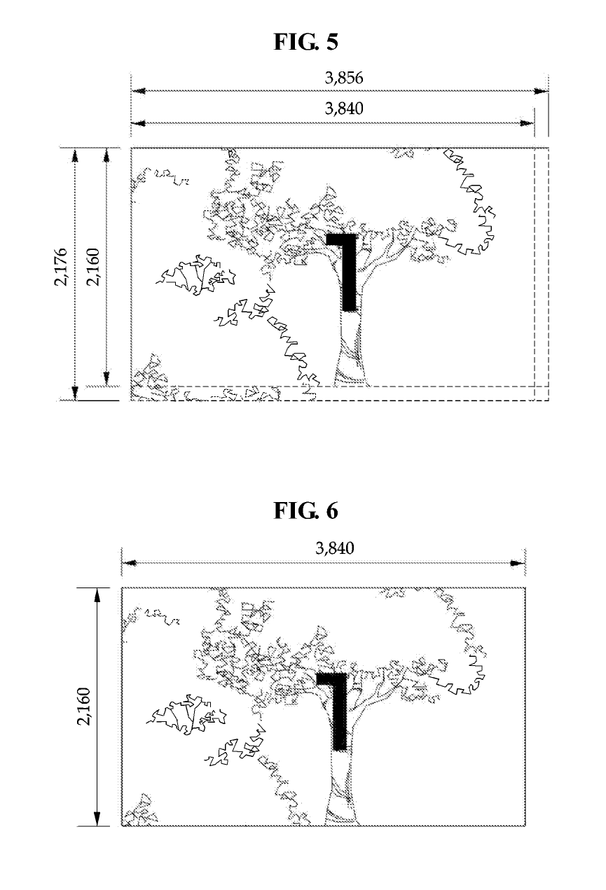

In some exemplary implementations, as illustrated in FIG. 5, the first sub-scaler 310 upscales the first sub-image having a resolution of 1,928*1088 and outputs a upscaled sub-image having a resolution of 3856*2176.

The upscaled sub-image is input to the extra image removing unit 400. The extra image removing unit 400 removes the upscaled extra images from the upscaled sub-image to fit into a corresponding panel area. In other words, the dividing control unit 200 divides the input image 100 to prevent a visible boundary between the panel areas. The upscaled sub-image need be consistent with the display panel 500 in terms of resolution to be supplied to the respective panel areas 510, 520, 530, and 540 as an image signal. Thus, it is necessary to remove the extra images from the upscaled sub-image by the extra image removing unit 400.

The removing unit 400 may include at least one sub-removing unit of which the number may be equal to the number of the sub-images divided by the dividing control unit 200. According to an embodiment of the disclosed technology, the dividing control unit 200 divides the input image 100 into four sub-images, and thus the extra image removing unit 400 may have four sub-removing units 410, 420, 430, and 440 as illustrated in FIG. 1.

The first sub-removing unit 410 may remove the extra images from the upscaled first sub-image, the second sub-removing unit 420 may remove the extra images from the upscaled second sub-image, the third overlap removing unit 430 may remove the extra images from the upscaled third sub-image, and the fourth sub-removing unit 440 may remove the extra images from the upscaled forth sub-image.

FIG. 6 is a diagram showing an upscaled image (3,840*2,160) from which the extra images are removed by the extra image removing unit 400. As illustrated in FIG. 6, image data having the same resolution as that of each of the partitioned display panels 510, 520, 530, and 540 may be obtained.

The upscaled sub-prototype images, from which the extra images are removed by the sub-removing units 410, 420, 430, and 440, may be supplied to timing controllers 613, 623, 633, and 643 respectively. The data signals corresponding to the upscaled sub-prototype images supplied to each of the timing controllers 613, 623, 633, and 643 may be finally supplied to the sub-panels 510, 520, 530, and 540 respectively in order to be displayed.

For purposes of summarizing the disclosed technology, certain aspects, advantages and novel features of the disclosed technology have been described herein. It is to be understood that not necessarily all such advantages is achieved in accordance with any particular embodiment of the disclosed technology. Thus, the disclosed technology is embodied or carried out in a manner that achieves or optimizes one advantage or group of advantages as taught herein without necessarily achieving other advantages as is taught or suggested herein.

Various modifications of the above described embodiments will be readily apparent, and the generic principles defined herein is applied to other embodiments without departing from the spirit or scope of the disclosed technology. Thus, the disclosed technology is not intended to be limited to the embodiments shown herein but is to be accorded the widest scope consistent with the principles and novel features disclosed herein.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the disclosed technology have been described with reference to the figures, it will be understood by those of ordinary skill in the art that various changes in form and details may be made therein without departing from the spirit and scope of the disclosed technology as defined by the following claims.

What is claimed is:

1. A display device comprising:
a display panel partitioned into a plurality of panel areas;
a dividing control unit configured to divide an input image into a plurality of sub-images, wherein each of the sub-images includes a sub-prototype image and extra images, the sub-prototype image corresponding to a panel area and the extra images corresponding to at least one boundary of the adjacent panel areas;
a scaler configured to scale the sub-images;
an extra image removing unit configured to remove an scaled extra image from the scaled sub-image such that the sub-image fits into the corresponding panel area; and
a driver configured to provide the scaled sub-prototype image to the corresponding panel area.

2. The display device of claim 1, wherein the sub-prototype image is image data corresponding to a panel area partitioned in a lattice form.

3. The display device of claim 1, wherein the sub-prototype image is image data corresponding to a panel area partitioned in a horizontal direction.

4. The display device of claim 1, wherein the sub-prototype image is image data corresponding to a panel area partitioned in a vertical direction.

5. The display device of claim 1, wherein the extra image includes image data corresponding to 4 to 12 pixel lines widthwise and/or lengthwise.

6. The display device of claim 1, wherein the scaler comprises sub-scalers of which the number is equal to the number of the sub-images.

7. The display device of claim 1, wherein the scaler converts low-resolution image data into high-resolution image data.

8. The display device of claim 7, wherein the scaler comprises a high-definition scaler configured to scale a standard-definition input image.

9. The display device of claim 7, wherein the scaler comprises an ultra-definition scaler configured to scale a high-definition input image.

10. The display device of claim 1, wherein the driver comprises:
a data driving unit configured to apply a data signal to the panel area;
a gate driving unit configured to apply a scan signal to the panel area; and
a timing controller configured to apply a timing signal to the data driving unit and the gate driving unit.

11. The display device of claim 1, wherein the display panel has higher resolution than ultra definition.

12. The display device of claim 1, wherein the display panel comprises a quad ultra definition display panel.

13. The display device of claim 1, wherein the dividing control unit partitions the input image into at least four sub-images, and wherein the scaler comprises four sub-scalers.

14. The display device of claim 1, wherein the dividing control unit partitions the input image into at least four sub-images, and wherein the extra image removing unit comprises four sub-removing units.

15. A driving method of a display device, the driving method comprising:
dividing an input image into a plurality of sub-images, wherein each of the sub-images includes a sub-prototype image and an extra image, the sub-prototype image corresponding to a panel area and the extra image corresponding to at least one boundary of the adjacent panel areas;
scaling the sub-images;
removing a scaled extra image from the scaled sub-image such that the sub-image fits into the corresponding panel area; and
displaying the scaled sub-prototype image on the corresponding panel area.

16. The driving method of claim 15, wherein dividing the input image comprises dividing the input image into sub-images in a lattice shape so as to display the sub-images in a lattice form.

17. The driving method of claim 15, wherein dividing the input image comprises dividing the input image into four sub-images.

18. The driving method of claim 15, wherein the extra image includes image data corresponding to 4 to 12 pixel lines widthwise and/or lengthwise.

19. The driving method of claim 15, wherein the scaling converts low-resolution image data into high-resolution image data.

20. A display device comprising:
means for displaying images partitioned into a plurality of meanses of displaying sub-images;
means for dividing an input image into a plurality of sub-images, wherein each of the sub-images includes a sub-prototype image and an extra image, the sub-prototype image corresponding to one of the meanses of displaying sub-images and the extra image corresponding to at least one boundary of the adjacent meanses of displaying sub-images;
means for scaling the sub-images;
means for removing a scaled extra image from the scaled sub-image such that the sub-image fits into the corresponding means of display sub-images; and
means for displaying the scaled sub-prototype image on the corresponding means of displaying sub-images.
